(19) United States
(12) Patent Application Publication
(10) Pub. No.: US 2009/0090431 A1
(43) Pub. Date: Apr. 9, 2009

(54) SYSTEM AND APPARATUS FOR DISPENSING CONCENTRATED MATERIALS

(75) Inventors: R. Bruce Yacko, Toledo, OH (US); Edward L. Mueller, Toledo, OH (US); Jeffrey C. Gayer, Sylvania, OH (US); Douglas F. Taylor, Toledo, OH (US); Luke Stonis, Columbus, OH (US); Gary E. Myers, New Albany, OH (US); Tim C. Rothwell, Dublin, OH (US); Robert J. Hayes, Lewis Center, OH (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: IDISPENSE LLC, Toledo, OH (US)

(21) Appl. No.: 12/210,746

(22) Filed: Sep. 15, 2008

Related U.S. Application Data
(60) Provisional application No. 60/993,578, filed on Sep. 13, 2007.
(60) Provisional application No. 61/061,677, filed on Jun. 16, 2008.

(51) Int. Cl. B67D 5/08; B65B 1/04

(52) U.S. Cl. 141/26; 141/192; 141/94; 141/95; 141/322

(57) ABSTRACT

A dispensing source container suitable for containing and dispensing fluid concentrate has an opening suitable for receiving a closure. The source container includes a fluid-tight vessel configured to hold fluid concentrate, and a pump connectable to the opening of the source container, the pump having a temporary reservoir, the pump being operable to withdraw a portion of the fluid concentrate from the source container and to store the portion of fluid concentrate in the temporary reservoir. The pump is also operable to dispense a metered amount of the fluid concentrate from the temporary reservoir to dispense the fluid concentrate from the source container into receiving containers.

### TECHNICAL FIELD

This invention relates to a mechanism and method for dispensing concentrates into receiving containers.

### BACKGROUND OF THE INVENTION

Cleaning and disinfectant solutions and other chemical compositions can be dispensed from receiving containers, such as spray bottles. Typically, a flow of diluent, such as water, is supplied with a small amount of concentrate, such as soap or other chemical concentrate, through a venturi to make a desired mixture or solution. The mixture is then delivered to a receiving container, such as a hand held spray bottle.

### SUMMARY OF THE INVENTION

According to this invention there is provided a dispensing source container suitable for containing and dispensing fluid concentrate, the source container having an opening suitable for receiving a closure. The source container includes a fluid-tight vessel configured to hold fluid concentrate, and a pump connectable to the opening of the source container, the pump having a temporary reservoir, the pump being operable to withdraw a portion of the fluid concentrate from the source container and to store the portion of fluid concentrate in the temporary reservoir. The pump is also operable to dispense a metered amount of the fluid concentrate from the temporary reservoir to dispense the fluid concentrate from the source container into receiving containers.

According to this invention there is also provided a dispensing apparatus for dispensing fluid concentrate from a plurality of source containers into a receiving container, the source containers having a uniform opening suitable for receiving a closure. The apparatus includes a connection that enables the apparatus to connect to the opening of any one of the source containers. The apparatus includes a pump configured to be positioned into any one of the source containers and configured to withdraw a portion of the fluid concentrate from the source container and to store the portion of fluid concentrate in a temporary reservoir. The apparatus is also configured to dispense a metered amount of the fluid concentrate from the temporary reservoir to dispense the fluid concentrate into receiving containers.

According to this invention there is also provided a dispensing source container suitable for containing and dispensing fluid concentrate, where the source container includes a fluid-tight vessel configured to hold fluid concentrate, and a pump mounted within the source container, the pump having a temporary reservoir, the pump being operable to withdraw a portion of the fluid concentrate from the source container and to store the portion of fluid concentrate in the temporary reservoir. The pump is also operable to dispense a metered amount of the fluid concentrate from the temporary reservoir to dispense the fluid concentrate from the source container into receiving containers. One or more outlet valves control the flow of fluid concentrate from the temporary reservoir to the receiving containers. A flushing system is configured to flush the outlet valves.

According to this invention there is also provided a dispensing source container suitable for containing and dispensing fluid concentrate. The source container includes a fluid-tight vessel configured to hold fluid concentrate, with a source container outlet opening suitable for discharging fluid concentrate from the source container, wherein the source container outlet opening is connected to a conduit containing a flow of diluent. A pump is connected to the source container, the pump having a temporary reservoir, the pump being operable to withdraw a portion of the fluid concentrate from the source container and to store the portion of the fluid concentrate in the temporary reservoir, wherein the pump is also operable to dispense a metered amount of the fluid concentrate from the temporary reservoir through the outlet opening and into the conduit.

According to this invention there is also provided a dispensing source container suitable for containing and dispensing fluid concentrate. The source container includes a fluid-tight vessel configured to hold fluid concentrate, with a source container outlet opening suitable for discharging fluid concentrate from the source container. A pump is connected to the source container, the pump having a temporary reservoir, the pump being operable to withdraw a portion of the fluid concentrate from the source container and to store the portion of the fluid concentrate in the temporary reservoir. A controller is connected to the pump and operable to control the pump, wherein the controller is configured to monitor the withdrawal of fluid concentrate from the vessel and to prevent the pump from attempting to withdraw fluid concentrate from the vessel after the vessel has been emptied.

According to this invention there is also provided apparatus for dispensing fluid concentrate from a source container into a receiving container. The apparatus includes a piston pump including a temporary reservoir, a piston shaft, and a piston shaft, with the piston having a hollow center passageway to allow the fluid concentrate to flow upwardly through the piston when the piston is moved downwardly. The piston has a one-way discharge valve configured to limit the flow of the has a one-way inlet valve at its lower end to allow upward flow of concentrate into the piston pump, but prevent downward flow of concentrate out of the piston pump.

According to this invention there is also provided apparatus for dispensing fluid concentrate from a source container into a receiving container. The apparatus includes a piston pump including a temporary reservoir and a piston. The piston pump has a one-way inlet valve to allow the fluid concentrate to flow into the piston temporary reservoir when the piston is moved upwardly. The piston pump has a one-way outlet valve at its lower end to allow downward flow of concentrate from the piston pump when the piston is moved downwardly. The piston pump is readily removable and replaceable with respect to the source container.

According to this invention there is also provided a container filling apparatus having at least one source container containing a fluid concentrate. A dispensing mechanism is structured to dispense fluid concentrate from the source container into a receiving container. A reading mechanism is capable of reading data from a data indicator on the receiving container, wherein the data indicator identifies data about the receiving container. A controller is configured to receive data from the dispensing mechanism pertaining to the dispensing of fluid concentrate into the receiving container. A transmitter is connected to the controller and configured to send a signal to the receiving container to modify the data on the data indicator of the receiving container in response to the dispensing of fluid concentrate into the receiving container.

According to this invention there is also provided a container filling apparatus having at least one source container containing a fluid concentrate, the source container having a data indicator identifying data about the source container. A dispensing mechanism is structured to dispense fluid concentrate from the source container into a receiving container. A reading mechanism is capable of reading data from a data indicator on the receiving container, wherein the data indicator identifies data about the receiving container. A controller is configured to receive data from the dispensing mechanism pertaining to the dispensing of fluid concentrate from the source container into the receiving container. A transmitter is connected to the controller and configured to send a signal to the source container to modify the data on the data indicator of the source container.

According to this invention there is also provided a container filling apparatus having at least one source container containing a fluid concentrate, the source container having a data indicator identifying data about the source container. A dispensing mechanism is structured to dispense fluid concentrate from the source container into a receiving container. A reading mechanism is capable of reading data from a data indicator on the source container. A controller is configured to receive data from the source container and the dispensing mechanism pertaining to the dispensing of fluid concentrate from the source container into the receiving container. A transmitter is connected to the controller and configured to send a signal to the source container to modify the data on the data indicator of the source container.

According to this invention there is also provided a container filling apparatus including at least one source container containing a fluid concentrate, the source container having a data indicator identifying data about the source container. A dispensing mechanism is structured to dispense fluid concentrate from the source container into a receiving container. A reading mechanism is capable of reading data from a data source container. A controller is configured to receive data from the source container and the dispensing mechanism pertaining to the dispensing of fluid concentrate from the source container into the receiving container. The controller is configured to receive data from an additional source container of fluid concentrate, the additional source container having a data indicator identifying data about the additional source container, and to control the dispensing mechanism in response to data on the data indicator of the additional source container.

According to this invention there is also provided a container filling apparatus including at least one source container containing a fluid concentrate, the source container having a data indicator identifying data about the source container. A dispensing mechanism is structured to dispense fluid concentrate from the source container into a receiving container. A reading mechanism is capable of reading data from a data indicator on the source container. A controller is configured to receive data from the source container and the dispensing mechanism pertaining to the dispensing of fluid concentrate from the source container into the receiving container, wherein the controller is configured to supply the data to an inventory supply and management system.

According to this invention there is also provided a container filling apparatus having at least one source container containing a fluid concentrate, the source container having a data indicator identifying data about the source container. A dispensing mechanism is structured to dispense fluid concentrate from the source container into a receiving container. A reading mechanism is capable of reading data from a data indicator on the source container. A controller is configured to receive data from the source container and the dispensing mechanism pertaining to the dispensing of fluid concentrate from the source container into the receiving container. A transmitter is connected to the controller and configured to send a signal to the source container to modify the data on the data indicator of the source container. The controller is configured to send a signal to the source container data indicator foreclosing additional dispensing from the source container when the source container reaches a predetermined condition.

According to this invention there is also provided a container filling apparatus including a dispensing mechanism structured to dispense fluid concentrate from source containers into a receiving containers, wherein the source containers have data indicators identifying data about the source container, including data pertaining to the origin of the source container. A reading mechanism is capable of reading data from the data indicators on the source containers. A controller is configured to receive data from the source container and to control the dispensing of the fluid concentrate into receiving containers, the controller being configured to initialize itself upon receiving origin data from a first source container wherein the controller becomes configured to accept source containers only from the origin of the first source container, and to prevent dispensing of the fluid concentrate from source containers from a different origin.

Various advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic view in elevation of a concentrate dispensing system.

FIG. 2 is an exploded schematic view of the piston pump of FIG. 1.

FIG. 3 is a cross-sectional view of the piston pump of FIG. 1.

FIG. 4 is plan view of the cap of the piston pump.

FIG. 5 is a plan view of the top plate of the piston pump.

FIG. 6 is a cross-sectional view of an embodiment of a discharge valve of a piston pump including a flushing system.

FIG. 7 is a cross-sectional view in elevation of another embodiment, including peristaltic pump.

FIG. 8 is a schematic view in elevation of another embodiment of a concentrate dispensing system, wherein the fluid concentrate is discharged upwardly is by a piston pump.

FIG. 9 is a cross-sectional view of the piston pump of FIG. 8.

FIG. 10 is a cross-sectional view in elevation of yet another embodiment, having a bag for containing the concentrate.

FIG. 11 is a view of the embodiment of FIG. 10, with the bag partially collapsed.

### DETAILED DESCRIPTION OF THE INVENTION

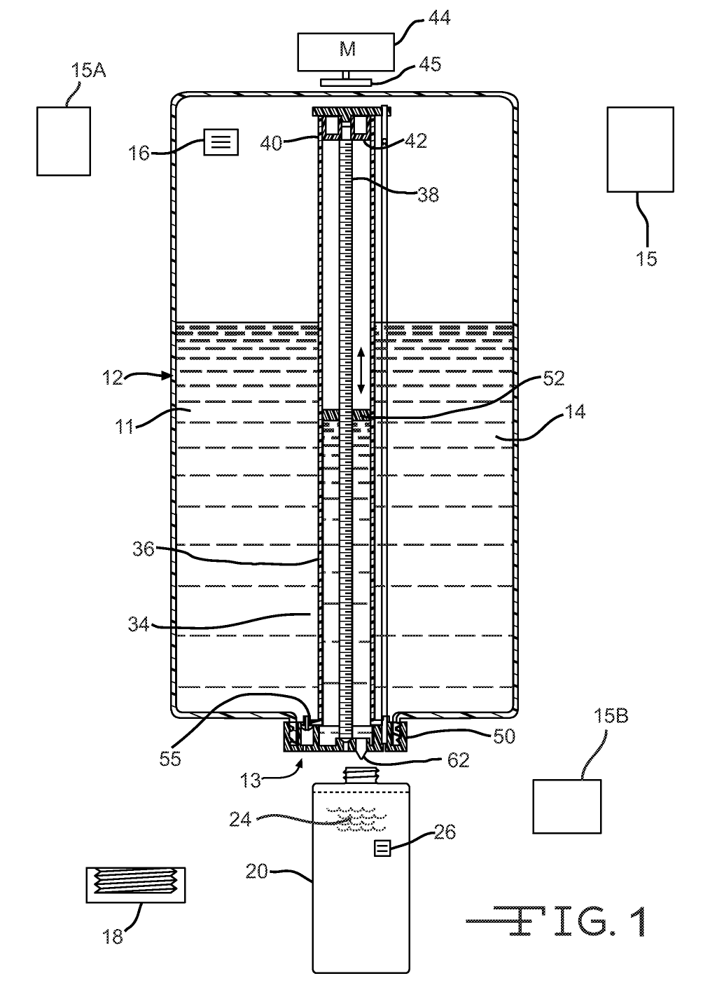

As shown in FIG. 1, the system for dispensing concentrated materials, indicated generally at 10, includes a source container 12 having a fluid-tight vessel 11 for holding the fluid concentrate 14. The source container 12 optionally includes machine-readable indicia, such as an RFID label 16, to indicate to a controller 15, via a reader, not shown, the content or composition of the concentrate 14. In other embodiments, there is no machine-readable indicia. The source container can be of many different configurations, but includes the fluid-tight vessel 11 configured to hold the fluid concentrate. Any number of concentrated fluids can be dispensed, such as, for example, concentrated soap, concentrated disinfectants, and concentrated food. A receiving container 20 is positionable beneath the source container 12 to receive the concentrate 14. In one embodiment, the receiving container is filed with diluent 24, such as water, before a small amount of the concentrate 14 is added. The receiving container 20 optionally includes machine-readable indicia, such as an RFID label 26, to indicate to the controller 15, via a scanner, not shown, the size and nature of the receiving container 20. An appropriate receiving container top, not shown, with a spray handle, is typically associated with the receiving container 20. Other types of receiving containers, such as mop buckets, can be used.

The source container includes a discharge opening generally indicated at 13. This opening 13 optionally can be configured with a threads to receive a removable, threaded cap 18 during shipping and storage of the source container 12.

Positioned within the source container 12 is piston pump 34. The piston pump 34 is configured to withdraw the concentrate 14 from the source container vessel 11 and then dispense the concentrate in a controlled manner through an exit valve 62 in the discharge opening 13, and into the receiving container 20. The piston pump 34 includes a chamber or temporary reservoir 36 for receiving and dispensing concentrate, a plunger or piston shaft 38, and a piston head 52. The temporary reservoir 36 serves to hold fluid concentrate 14 as needed during the process of dispensing the fluid concentrate. The piston shaft 38 can be any suitable length. The piston shaft 38 can be operated by any suitable means, as will be explained below. In one embodiment the piston pump 34 is a syringe pump.

The piston head 52 is connected to the piston shaft 38 and is mounted for axial movement through the temporary reservoir 36. The movement of the piston head 52 through the temporary reservoir 36 can be accomplished in any suitable manner. In the embodiment shown in FIG. 1, the piston head 52 is mounted with a threaded connection to the piston shaft 38, which is a rotatable threaded shaft. Rotation of the shaft 38 causes the piston head 52 to move vertically up or down within the temporary reservoir. Downward movement of the piston head 52 causes the concentrate 14 within the temporary reservoir 36 of the piston pump 34 to be moved downwardly, through the one-way exit valve 62 and into the receiving container 20. Movement upward causes the temporary reservoir 36 to be filled by withdrawing concentrate 14 from the surrounding vessel 11 of the source container 12.

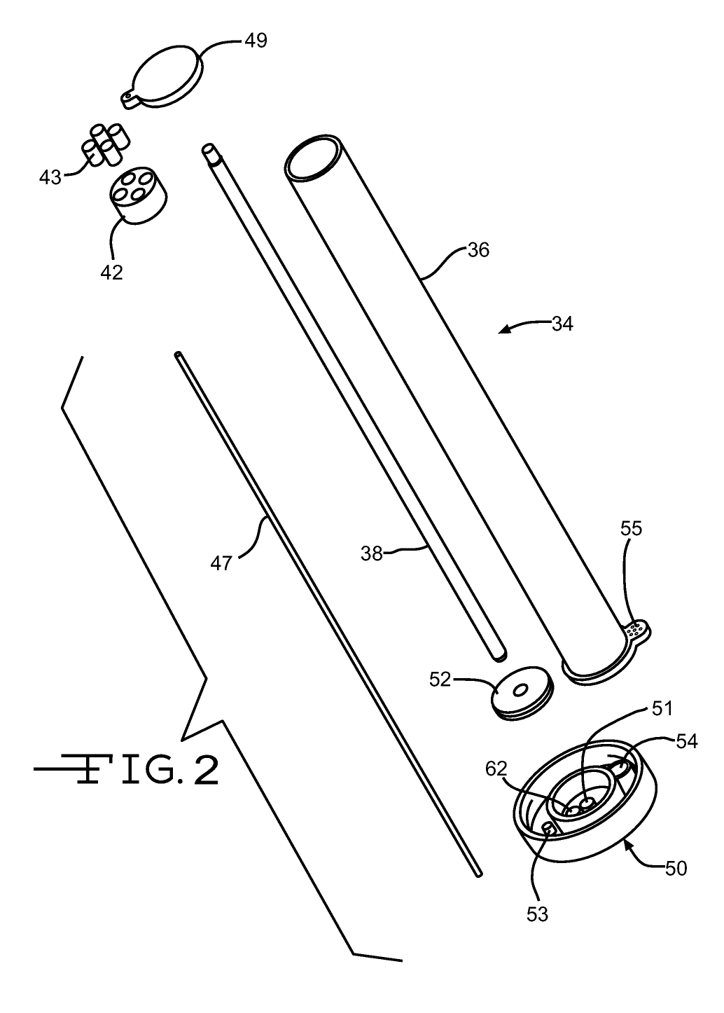

As shown in FIGS. 1-3, the shaft 38 includes at its top end 40 a bearing journal 41 to mount the shaft 38 for rotation. Also at the top of the shaft is a rotatably mounted hub 42 which is configured to hold magnets 43. Other schemes for holding the magnets 43 can be used. Positioned in close proximity to the hub 42 containing the magnets 43 is a stepper motor 44 connected to a rotatable motor magnet 45. The stepper motor 44 is configured to rotate the rotatable motor magnet 45 in discrete, is measured rotational increments in response to signals from the controller 15. The stepper motor 44 and rotatable magnet 45 are shown as being outside the source container 12. It is to be understood that in other embodiments the rotatable magnet 45 can be positioned within the source container 12. The rotatable magnet 45 is aligned with the hub 42 and magnets 43 so that rotation of the rotatable magnet 45 will cause a corresponding rotation of the hub 42, and therefore a rotation of the threaded shaft 38. Rotation of the shaft 38 in turn causes movement of the piston head 52 axially within the temporary reservoir. It is to be understood that other means besides a stepper motor 44 can be used for rotating the rotatable magnet 45. Also, other mechanisms beside rotating magnets, such as for example, a vacuum system, can be used to move the piston head 52 up and down within the temporary reservoir 36.

As shown in FIGS. 1-5, the piston pump 34 includes an optional vent tube 47 for venting the vessel 11 of the source container 12 as the fluid 14 is removed during dispensing operations. A check ball 48 can optionally be positioned in the vent tube 47. Other means of venting the vessel 11 can be used.

A cap 49 can be placed on the top of the temporary reservoir 36 for seating the hub 42, the shaft 38, and the vent tube 47, and for sealing the temporary reservoir 36.

Positioned at the bottom of the piston pump 34 is a piston mounting cap 50. The piston cap 50 is provided with threads to enable the cap 50 and piston pump 34 to be threaded onto the opening 13 of the source container 12 in a fluid-tight connection after removal of the shipping cap 18. The cap 50 includes a mounting for the piston pump 34 and for the exit valve 62, and also provides a seat or bearing 51 for the shaft 38. The cap further includes a seat 53 for the vent tube 47.

The one-way exit valve 62 can be any valve suitable for controlling the flow of fluid concentrate from the temporary reservoir to the receiving containers. In the illustrated embodiment, a one-way duckbill valve is used. Other valves can be is used. The valve need not be a one-way valve, but a one-way valve gives the advantage avoiding the inspiration of air during the filling of the temporary reservoir 36 when the piston head 52 is drawn up. Although a single valve 62 is shown, one or more valves controlling the flow of fluid concentrate 14 from the temporary reservoir 38 to the receiving containers 20 can be used.

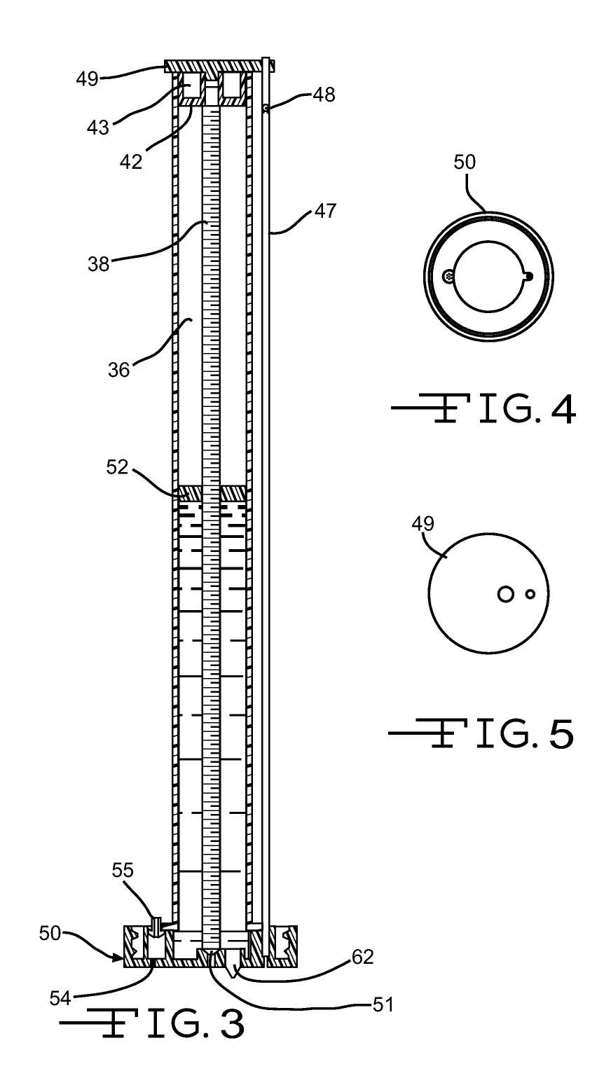

An intake chamber or well 54 is mounted in the cap 50 to provide access or fluid communication from the vessel 11 to the temporary reservoir 36. The flow of fluid concentrate 14 between the vessel 11 and the temporary reservoir 36 is controlled by one or more inlet valves 55. The inlet valve 55 can be an umbrella valve, as shown in FIG. 4, or any other suitable valve. It is advantageously a one-way valve to prevent reintroduction of the fluid concentrate into the source container vessel 11 during downward pumping of the piston 34.

In typical operation, the stepper motor 44 is first operated to drive the piston head 52 to the bottom of the temporary reservoir 36 of the piston pump 34. Then the piston head 52 is moved upward, drawing fluid concentrate 14 through the inlet valve 55 into the temporary reservoir 36. In one embodiment of operation, the receiving container is filled with diluent, such as water, before the addition of a small amount of the fluid concentrate. When a discharge of concentrate is desired, the stepper motor 44 moves the piston head 52 incrementally downward, forcing the desired amount of concentrate to flow downward through the one-way exit valve 62 and into the receiving container 20. Once all of the concentrate 14 in the temporary reservoir 36 is discharged into a multiplicity of receiving containers 20, the stepper motor 44 is operated to raise the piston head 52 again, thereby refiling the temporary reservoir 36 of the piston pump 34 with additional concentrate from the vessel 11.

It is to be understood that after the source container 12 is filled by the supplier of the concentrate material, the source container can be shipped with the pump 34 positioned within the source container, or in the alternative can be shipped with the pump accompanying the source container.

If the pump is shipped outside of the source container, the customer using the dispensing apparatus removes the shipping cap 18 and installs the pump 34 before using the apparatus. Further, the pump can be part of a dispensing apparatus for dispensing fluid concentrate from a plurality of source containers into a receiving container, where the source containers have a uniform opening suitable for receiving a closure, such as the shipping bottle cap 18. The apparatus includes a connection (e.g. threaded connection) that enables the apparatus to connect to the opening of any one of the plurality of source containers. The apparatus includes a pump configured to be positioned into any one of the source containers and configured to withdraw a portion of the fluid concentrate from the source container and to store the portion of fluid concentrate in a temporary reservoir. The apparatus also can be configured to dispense a metered amount of the fluid concentrate from the temporary reservoir to dispense the fluid concentrate into receiving containers.

Although in the embodiment illustrated in FIGS. 1-5 shows the temporary reservoir 36 being positioned within the piston pump 34, the temporary reservoir can be external of the piston pump. Further, although the piston pump 34 is illustrated as being within the source container 12, the piston pump can be external of the source container 12, such as, for example with a conduit, not shown, connecting the fluid concentrate in the source container with the temporary reservoir of the pump. In the embodiment illustrated in FIGS. 1-5 the diluent is described as being water. It is to be understood that the diluent can be other substances, such as solvents, alcohol, sterile solutions, and other hygienic solutions. Further, although the fluid concentrate has been illustrated and described as being a liquid, it is to be understood that the term “fluid concentrate” includes gels and finely divided solids, such as powders and granular materials. In one embodiment, the fluid concentrate is a concentrated pharmacological substance. The concentrated pharmacological substance is metered out or dispensed in a precise, measured way with the pump of the dispensing source container.

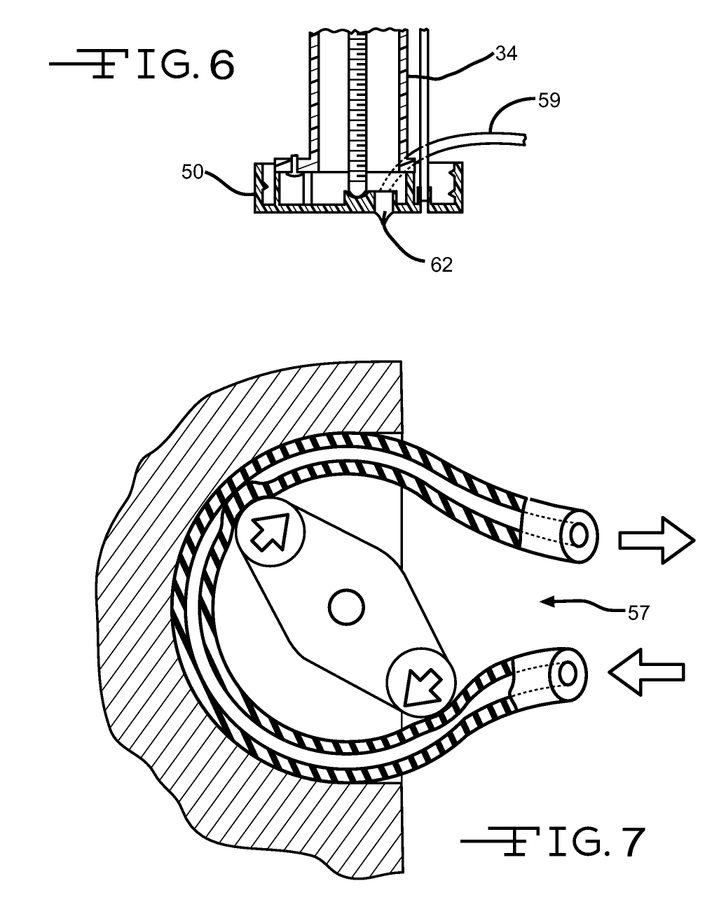

In one embodiment, the system 10 for dispensing concentrate includes a flushing system for minimizing contamination of the apparatus. As shown in FIG. 6, a hose or other conduit 59 is connected to a source of flushing fluid, such as water. A valve, not shown, is controlled by the controller 15, to manage the flow of flushing fluid through the outlet valve 62. The flushing system can be configured in any manner to allow the apparatus to be flushed.

The flushing system can be modified to be used as a venturi system for filling receiving containers. The venturi system would include a pump connected to the source container, the pump having a temporary reservoir, the pump being operable to withdraw a portion of the fluid concentrate from the source container and to store the portion of the fluid concentrate in the temporary reservoir. The pump is operable to dispense a metered amount of the fluid concentrate from the temporary reservoir through the outlet opening and into the conduit 59. The proper amount of fluid concentrate is dispensed into the conduit 59 to result in the desired concentration of liquid in the receiving container.

Although in the embodiment shown in FIGS. 1-5 the piston pump 34 is a syringe pump, other types of pumps can be used. For example, a peristaltic pump 57, shown in FIG. 7, can be used. Examples of other pumps that can be used include a rolling bellows pump and a collapsable bag pump.

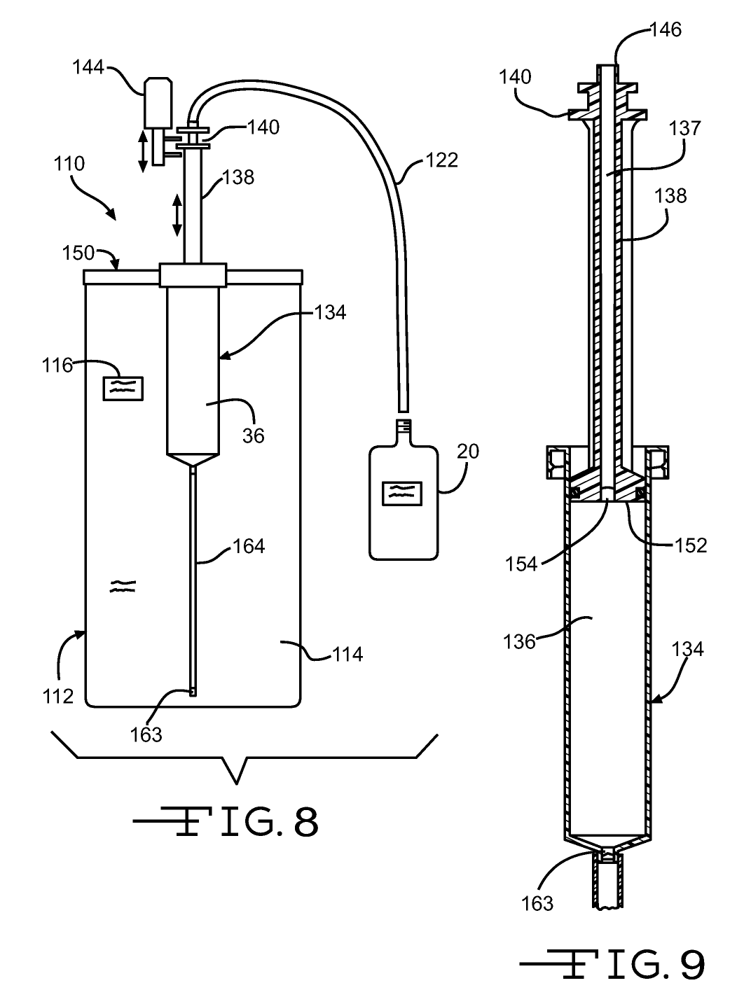

FIGS. 8 and 9 illustrate a system 110 wherein a source container 112 has its opening at the top, and a piston pump 134 is positioned inside the source container to dispense fluid concentrate 114 into a receiving container 20. The piston 134 has a piston shaft 138 that includes a top end 140 with a connection configured to connect to a stepper motor 144. The stepper motor is arranged to drive the piston 138 and its piston head 152 up or down in the piston temporary reservoir 136. The piston also includes a hollow center passageway 137 to the allow the fluid concentrate to flow upwardly through the piston when the piston shaft 138 is moved downwardly. The passageway 137 terminates in a fitting 146 for connection with a distribution tube 122. A cap 150 at the top end 140 of the piston pump 134 is threaded for connection with the cap 150 of the source container 112. Any suitable connection can be used.

The piston head 152 is provided with a one-way discharge valve 154 that allows fluid flow only in the upward direction, into the passageway 44. A seal, not shown, seals the piston head 152 against the walls of the temporary reservoir 136. The lower end of the piston pump 134 includes a suction valve or inlet valve 163, which can be a duck bill valve or any other suitable one-way valve. The inlet valve 163 can be connected to the dip tube 164 which is sized to connect the piston pump 34 to the bottom area of the temporary reservoir 136.

In typical operation, the stepper motor 144 is first operated to drive the piston shaft 138 to the bottom of the temporary reservoir 136 of the piston pump 134. Then the piston moved upward, drawing fluid concentrate 114 through the inlet valve 163 into the temporary reservoir 136. When a discharge of concentrate is desired, the stepper motor 144 moves the piston shaft 138 incrementally downward, forcing the desired amount of concentrate to flow upward through the discharge valve 154, through the hollow center passageway 137, and along the distribution tube 122 to the receiving container 120.

It is to be understood that in any of the embodiments, the stepper motor 44 or 144 can be controlled by the controller 15, and the controller can be configured to keep track of the amount of concentrate dispensed, and to prevent unauthorized discharging from, tampering with, or filling of the source container 12 or 112.

While in the embodiment illustrated in FIGS. 7-8 the source container 112 is shown as being upright, and in the embodiment shown in FIGS. 1-5 the source container 12 is shown as being inverted, it is to be understood that the source container and piston pumps can be oriented in any suitable orientation.

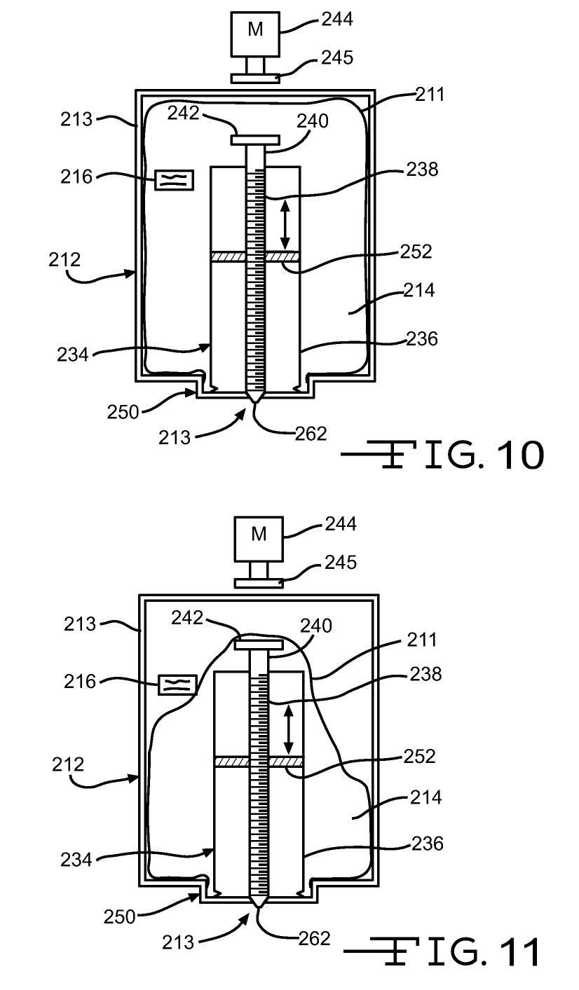

In the embodiment shown in FIGS. 10 and 11, the source container 212 and piston pump 236 are largely similar to the corresponding elements of the embodiment shown in FIGS. 1-5. However the source container 212 is comprised of a bottle, container, or other mounting structure 213 configured to support a bag 211 containing a quantity of fluid concentrate, and the bag 211 becomes the fluid tight vessel. The piston pump 234 includes a piston shaft 238 on which is mounted the head 252. The bottom cap 250 includes a one-way exit valve 262 for discharging the fluid concentrate into the receiving container. As the concentrated material 214 is consumed or dispensed by the downward movement of the piston head 252, the bag 211 will collapse, as shown in FIG. 11. This embodiment has the advantage of reducing the amount container material remaining after all the concentrate as been dispensed from the source container.

In one embodiment, as shown in FIG. 1, a reading mechanism 15A is capable of reading data from a data indicator 16 on the source container. The reading mechanism 15A is connected to the controller 15 y any suitable means. Further, a reading mechanism 15B can be associated with the data indicator 26 on the receiving container 20, and this reading mechanism is also connected to the controller 15. Optionally, the reading mechanisms 15A and 15B can be equipped with transmitters suitable for sending signals to the respective data indicators 16 and 26 to modify the data in those respective data indicators.

The principle and mode of operation of this invention have been described in its preferred embodiments. However, it should be noted that this invention may be practiced otherwise than as specifically illustrated and described without departing from its scope.

1. A dispensing source container suitable for containing and dispensing fluid concentrate, the source container having an opening suitable for receiving a closure, the source container comprising:
a fluid-tight vessel configured to hold fluid concentrate;
a pump connectable to the opening of the source container, the pump having a temporary reservoir, the pump being operable to withdraw a portion of the fluid concentrate from the source container and to store the portion of fluid concentrate in the temporary reservoir;
wherein the pump is also operable to dispense a metered amount of the fluid concentrate from the temporary reservoir to dispense the fluid concentrate from the source container into receiving containers.

2. The dispensing source container of claim 1 wherein the pump is a piston pump.

3. The dispensing source container of claim 2 wherein the pump is a piston pump.

4. The dispensing source container of claim 1 wherein the pump is a peristaltic pump.

5. The dispensing source container of claim 1 including one or more inlet valves controlling the flow of fluid concentrate between the vessel and the reservoir, and one or more outlet valves controlling the flow of fluid concentrate from the temporary reservoir to the receiving containers.

6. The dispensing source container of claim 1 in which the pump is connectable to the opening of the source container

7. The dispensing source container of claim 1 in which the pump is a piston pump mounted within the source container, the piston pump having the temporary reservoir and a piston head mounted for movement within the temporary reservoir, the dispensing source container further including one or more inlet valves connected between the fluid-tight vessel and the temporary reservoir, and one or more outlet valves connected between the temporary reservoir and the source container outlet; and dispensing source container further including a mechanism operable to move the piston head within the temporary reservoir, wherein movement of the piston head in one direction draws fluid concentrate from the vessel into the temporary reservoir, and movement of the piston head in another direction dispenses fluid concentrate from the temporary reservoir and out of the source container via the source container outlet.

8. The dispensing source container of claim 7 in which the piston pump is a syringe pump that includes a threaded piston shaft connected to the piston head, and in which the mechanism for moving the piston head is a worm gear for moving the piston shaft within the temporary reservoir.

9. The dispensing source container of claim 8 in which the mechanism for moving the piston head includes:
a syringe magnet mounted at an end of the piston shaft, and
a rotatably mounted magnet external of the vessel, with the external rotatable magnet being positioned sufficiently close to the syringe magnet to effect rotation of the syringe magnet by rotation of the external rotatable magnet, wherein rotation of the syringe magnet rotates the piston shaft thereby enabling moving of the piston head within the temporary reservoir.

10. The dispensing source container of claim 9 including an air vent in the vessel.

11. A dispensing apparatus for dispensing fluid concentrate from a plurality of source containers into a receiving container, the source containers having a uniform opening suitable for receiving a closure, the apparatus including a connection that enables the apparatus to connect to the opening of any one of the source containers, the apparatus including a pump configured to be positioned into any one of the source containers and configured to withdraw a portion of the fluid concentrate from the source container and to store the portion of fluid concentrate in a temporary reservoir, the apparatus also configured to dispense a metered amount of the fluid concentrate from the temporary reservoir to dispense the fluid concentrate into receiving containers.

12. The dispensing apparatus of claim 11 in which the pump is a piston pump.

13. The dispensing apparatus of claim 11 including one or more inlet valves controlling the flow of fluid concentrate between the source container and the reservoir, and one or more outlet valves controlling the flow of fluid concentrate from the temporary reservoir to the receiving containers.

14. A dispensing source container suitable for containing and dispensing fluid concentrate, the source container comprising:
a fluid-tight vessel configured to hold fluid concentrate;
a pump mounted within the source container, the pump having a temporary reservoir, the pump being operable to withdraw a portion of the fluid concentrate from the source container and to store the portion of fluid concentrate in the temporary reservoir, wherein the pump is also operable to dispense a metered amount of the fluid concentrate from the temporary reservoir to dispense the fluid concentrate from the source container into receiving containers;
one or more outlet valves controlling the flow of fluid concentrate from the temporary reservoir to the receiving containers; and
a flushing system configured to flush the outlet valves.

15. The dispensing source container of claim 14 wherein the flushing system includes a conduit connected to a source of flushing fluid.

16. A dispensing source container suitable for containing and dispensing fluid concentrate, the source container comprising:
a fluid-tight vessel configured to hold fluid concentrate;
a source container outlet opening suitable for discharging fluid concentrate from the source container, wherein the source container outlet opening is connected to a conduit containing a flow of diluent; and
a pump connected to the source container, the pump having a temporary reservoir, the pump being operable to withdraw a portion of the fluid concentrate from the source container and to store the portion of the fluid concentrate in the temporary reservoir, wherein the pump is also operable to dispense a metered amount of the fluid concentrate from the temporary reservoir through the outlet opening and into the conduit.

17. A dispensing source container suitable for containing and dispensing fluid concentrate, the source container comprising:
a fluid-tight vessel configured to hold fluid concentrate;
a source container outlet opening suitable for discharging fluid concentrate from the source container;
a pump connected to the source container, the pump having a temporary reservoir, the pump being operable to withdraw a portion of the fluid concentrate from the source container and to store the portion of the fluid concentrate in the temporary reservoir; and
a controller connected to the pump and operable to control the pump, wherein the controller is configured to monitor the withdrawal of fluid concentrate from the vessel and to prevent the pump from attempting to withdraw fluid concentrate from the vessel after the vessel has been emptied.

18. Apparatus for dispensing fluid concentrate from a source container into a receiving container, the apparatus comprising:
a piston pump including a temporary reservoir, a piston shaft, and a piston shaft, with the piston having a hollow center passageway to allow the fluid concentrate to flow upwardly through the piston when the piston is moved downwardly;
the piston having a one-way discharge valve configured to limit the flow of the concentrate through the passageway to an upward direction only; and
the piston pump having a one-way inlet valve at its lower end to allow upward flow of concentrate into the piston pump, but prevent downward flow of concentrate out of the piston pump.

19. The apparatus of claim 18 in which the piston pump is configured to be readily removable and replaceable with respect to source containers of the concentrate.

20. Apparatus for dispensing fluid concentrate from a source container into a receiving container, the apparatus comprising a piston pump including a temporary reservoir and a piston:
the piston pump having a one-way inlet valve to allow the fluid concentrate to flow into the piston temporary reservoir when the piston is moved upwardly; and
the piston pump having a one-way outlet valve at its lower end to allow downward flow of concentrate from the piston pump when the piston is moved downwardly;
wherein the piston pump is readily removable and replaceable with respect to the source container.

21. A container filling apparatus comprising:
at least one source container containing a fluid concentrate;
a dispensing mechanism structured to dispense fluid concentrate from the source container into a receiving container;
a reading mechanism capable of reading data from a data indicator on the receiving container, wherein the data indicator identifies data about the receiving container;
a controller configured to receive data from the dispensing mechanism pertaining to the dispensing of fluid concentrate into the receiving container; and
a transmitter connected to the controller and configured to send a signal to the receiving container to modify the data on the data indicator of the receiving container in response to the dispensing of fluid concentrate into the receiving container.

22. The apparatus of claim 20 in which the controller is configured to modify the data on the data indicator of the receiving container to indicate the number of times the receiving container has been given fluid concentrate.

23. A container filling apparatus comprising:
at least one source container containing a fluid concentrate, the source container having a data indicator identifying data about the source container;
a dispensing mechanism structured to dispense fluid concentrate from the source container into a receiving container;
a reading mechanism capable of reading data from a data indicator on the receiving container, wherein the data indicator identifies data about the receiving container;
a controller configured to receive data from the dispensing mechanism pertaining to the dispensing of fluid concentrate from the source container into the receiving container; and
a transmitter connected to the controller and configured to send a signal to the source container to modify the data on the data indicator of the source container.

24. The apparatus of claim 23 in which the controller is configured to modify the data on the data indicator of the source container in response to the data on the receiving container.

25. The apparatus of claim 24 in which the controller is configured to modify the data on the data indicator of the source container by changing dosage data on the source container in response to the data on the receiving container.

26. A container filling apparatus comprising:
at least one source container containing a fluid concentrate, the source container having a data indicator identifying data about the source container;
a dispensing mechanism structured to dispense fluid concentrate from the source container into a receiving container;
a reading mechanism capable of reading data from a data indicator on the source container;
a controller configured to receive data from the source container and the dispensing mechanism pertaining to the dispensing of fluid concentrate from the source container into the receiving container; and
a transmitter connected to the controller and configured to send a signal to the source container to modify the data on the data indicator of the source container.

27. The apparatus of claim 26 in which the controller is configured to modify the data on the data indicator of the source container to indicate the amount of fluid concentrate remaining in the source container.

28. The apparatus of claim 26 in which the controller is configured to modify the data on the data indicator of the source container to indicate a dilution rate for the source container.

29. A container filling apparatus comprising:
at least one source container containing a fluid concentrate, the source container having a data indicator identifying data about the source container;
a dispensing mechanism structured to dispense fluid concentrate from the source container into a receiving container;
a reading mechanism capable of reading data from a data indicator in the source container; and
a controller configured to receive data from the source container and the dispensing mechanism pertaining to the dispensing of fluid concentrate from the source container into the receiving container;
wherein the controller is configured to receive data from an additional source container of fluid concentrate, the additional source container having a data indicator identifying data about the additional source container, and to control the dispensing mechanism in response to data on the data indicator of the additional source container.

30. A container filling apparatus comprising:
at least one source container containing a fluid concentrate, the source container having a data indicator identifying data about the source container;
a dispensing mechanism structured to dispense fluid concentrate from the source container into a receiving container;
a reading mechanism capable of reading data from a data indicator on the source container; and
a controller configured to receive data from the source container and the dispensing mechanism pertaining to the dispensing of fluid concentrate from the source container into the receiving container, wherein the controller is configured to supply the data to an inventory supply and management system.

31. A container filling apparatus comprising:
at least one source container containing a fluid concentrate, the source container having a data indicator identifying data about the source container;
a dispensing mechanism structured to dispense fluid concentrate from the source container into a receiving container;
a reading mechanism capable of reading data from a data indicator on the source container;
a controller configured to receive data from the source container and the dispensing mechanism pertaining to the dispensing of fluid concentrate from the source container into the receiving container; and
a transmitter connected to the controller and configured to send a signal to the source container to modify the data on the data indicator of the source container;
wherein the controller is configured to send a signal to the source container data indicator foreclosing additional dispensing from the source container when the source container reaches a predetermined condition.

32. The apparatus of claim 31 in which the predetermined condition is the emptying of the source container.

33. The apparatus of claim 31 in which the predetermined condition is the contamination of the source container.

34. The apparatus of claim 31 in which the data indicator of the source container is reprogrammable so that it can be reset to allow additional dispensing from the source container.

35. A container filling apparatus comprising:
a dispensing mechanism structured to dispense fluid concentrate from source containers into a receiving containers, wherein the source containers have data indicators identifying data about the source container, including data pertaining to the origin of the source container;
a reading mechanism capable of reading data from the data indicators on the source containers;
a controller configured to receive data from the source container and to control the dispensing of the fluid concentrate into receiving containers, the controller being configured to initialize itself upon receiving origin data from a first source container wherein the controller becomes configured to accept source containers only from the origin of the first source container, and to prevent dispensing of the fluid concentrate from source containers from a different origin.

36. The apparatus of claim 35 in which the controllable so that it can be reset to allow dispensing from source containers from a different origin.
